(19) United States
(12) Patent Application Publication
(10) Pub. No.: US 2018/0301680 A1
(43) Pub. Date: Oct. 18, 2018

(54) NONAQUEOUS ELECTROLYTE SECONDARY BATTERY INSULATING POROUS LAYER

(71) Applicant: Sumitomo Chemical Company, Limited, Tokyo (JP)

(72) Inventors: Ichiro ARISE, Osaka (JP); Junji SUZUKI, Niihama-shi (JP); Hiroki HASHIWAKI, Niihama-shi (JP); Chikara MURAKAMI, Osaka (JP)

(21) Appl. No.: 15/592,381

(22) Filed: May 11, 2017

(30) Foreign Application Priority Data
Apr. 14, 2017 (JP) 2017-080834

(51) Int. Cl. H01M 2/16

(52) U.S. Cl. CPC H01M 2/1686; H01M 2/1653

(57) ABSTRACT

A nonaqueous electrolyte secondary battery insulating porous layer having which is excellent in heat resistance and oxidation resistance in a battery is realized. A nonaqueous electrolyte secondary battery insulating porous layer includes aromatic polyester containing (A) a unit derived from aromatic hydroxycarboxylic acid, (B) a unit derived from aromatic dicarboxylic acid, (C) a unit derived from aromatic amine, selected from aromatic diamine and aromatic amine containing a hydroxyl group, and (D) a unit derived from aromatic diol, in respective predetermined ratios.

This Nonprovisional application claims priority under 35 U.S.C. § 119 on Patent Application No. 2017-080834 filed in Japan on Apr. 14, 2017, the entire contents of which are hereby incorporated by reference.

### TECHNICAL FIELD

The present invention relates to (i) an insulating porous layer for a nonaqueous electrolyte secondary battery (hereinafter referred to as a “nonaqueous electrolyte secondary battery insulating porous layer”), (ii) a laminated separator for a nonaqueous electrolyte secondary battery (hereinafter referred to as a “nonaqueous electrolyte secondary battery laminated separator”) etc.

### BACKGROUND ART

Nonaqueous electrolyte secondary batteries, particularly lithium secondary batteries, have high energy density and accordingly are widely used as batteries for personal computers, mobile phones, portable information terminals etc. Furthermore, recently, the nonaqueous electrolyte secondary batteries have been developed as on-vehicle batteries. As a member of the nonaqueous electrolyte secondary battery, a separator having excellent heat resistance has been developed.

For example, Patent Literature 1 discloses, as a nonaqueous electrolyte secondary battery separator having excellent heat resistance, a nonaqueous electrolyte secondary battery laminated separator which is a laminate consisting of (i) a polyolefin finely porous film and (ii) a porous layer which is on the finely porous film and which is made of aramid resin that is a heat-resistant resin.

### CITATION LIST

### Patent Literature

[Patent Literature 1]

Japanese Patent Application Publication No. 2001-23602 (published on Jan. 26, 2001)

### SUMMARY OF INVENTION

### Technical Problem

However, although the porous layer made of the aramid resin (heat-resistant resin) has sufficient heat resistance, oxidation resistance in a nonaqueous electrolyte secondary battery (which resistance may be hereinafter also referred to merely as “oxidation resistance in a battery”) is not yet sufficient.

### Solution to Problem

The present invention includes aspects shown in [1] through [4] below.

[1] A nonaqueous electrolyte secondary battery insulating porous layer comprising aromatic polyester,

the aromatic polyester containing, as constituent units, (A) a unit derived from aromatic hydroxycarboxylic acid, (B) a unit derived from aromatic dicarboxylic acid, (C) a unit derived from aromatic amine, selected from aromatic diamine and aromatic amine containing a hydroxyl group, and (D) a unit derived from aromatic diol,

the unit (A) being not less than 10 mol % and less than 30 mol %, the unit (B) being more than 35 mol % and not more than 45 mol %, and a sum of the unit (C) and the unit (D) being more than 35 mol % and not more than 45 mol % relative to 100 mol % in total number of moles of the units (A) through (D), and

a molar ratio (D)/(C) of the unit (D) to the unit (C) being not more than 0.75.

[2] A nonaqueous electrolyte secondary battery laminated separator comprising:

a porous base material containing a polyolefin-based resin as a main component; and

a nonaqueous electrolyte secondary battery insulating porous layer recited in [1], the nonaqueous electrolyte secondary battery insulating porous layer being disposed on at least one surface of the porous base material.

[3] A nonaqueous electrolyte secondary battery member comprising:

a cathode;

a nonaqueous electrolyte secondary battery insulating porous layer recited in [1], or a nonaqueous electrolyte secondary battery laminated separator recited in [2]; and

an anode,

the cathode, the nonaqueous electrolyte secondary battery insulating porous layer or the nonaqueous electrolyte secondary battery laminated separator, and the anode being arranged in this order.

[4] A nonaqueous electrolyte secondary battery comprising:

a nonaqueous electrolyte secondary battery insulating porous layer recited in [1]; or

a nonaqueous electrolyte secondary battery laminated separator recited in [2].

### Advantageous Effects of Invention

A nonaqueous electrolyte secondary battery insulating porous layer in accordance with an embodiment of the present invention advantageously has excellent oxidation resistance in a battery, as well as heat resistance.

### DESCRIPTION OF EMBODIMENTS

The following description will discuss an embodiment of the present invention. Note, however, that the present invention is not limited to configurations described below, but can be altered in many ways by a person skilled in the art within the scope of the claims. An embodiment derived from a proper combination of technical means disclosed in different embodiments is also encompassed in the technical scope of the present invention. Note that unless specified otherwise, any numerical range expressed as “A to B” herein means “not less than A and not greater than B”.

### Embodiment 1: Nonaqueous Electrolyte Secondary Battery Insulating Porous Layer

A nonaqueous electrolyte secondary battery insulating porous layer in accordance with Embodiment 1 of the present invention (hereinafter “nonaqueous electrolyte secondary battery insulating porous layer” may be referred to as “porous layer”) contains aromatic polyester which includes, as constituent units, (A) a unit derived from aromatic hydroxycarboxylic acid, (B) a unit derived from aromatic dicarboxylic acid, (C) a unit derived from aromatic amine, selected from aromatic diamine and aromatic amine containing a hydroxyl group, and (D) a unit derived from aromatic diol. The unit (A) is not less than 10 mol % and less than 30 mol %, the unit (B) is more than 35 mol % and not more than 45 mol %, and a sum of the unit (C) and the unit (D) is more than 35 mol % and not more than 45 mol % relative to 100 mol % in total number of moles of the units (A) through (D), and a molar ratio (D)/(C) of the unit (D) to the unit (C) is not more than 0.75.

A porous layer in accordance with an embodiment of the present invention can be formed on a base material of a nonaqueous electrolyte secondary battery separator and serve as a member of a nonaqueous electrolyte secondary battery laminated separator. The porous layer has many pores therein, the pores being connected to one another, so that a gas or a liquid can pass through the porous layer from one surface of the porous layer to the other. Furthermore, the porous layer can be a separator for a nonaqueous electrolyte secondary battery by being formed on an electrode.

<Aromatic Polyester>

Common names of polymers described herein each indicate a main binding type of the polymer. Accordingly, aromatic polyester is an aromatic polymer in which not less than 50% of bonds constituting a main chain in molecules of the aromatic polymer are ester bonds. “Aromatic polymer” indicates a polymer in which a monomer constituting the polymer contains an aromatic compound.

Aromatic polyester can contain, in bonds constituting a main chain, bonds other than ester bonds (such as amide bonds and imide bonds). The aromatic polyester is preferably wholly aromatic polyester.

In an embodiment of the present invention, aromatic polyester includes, as constituent units, (A) a unit derived from aromatic hydroxycarboxylic acid, (B) a unit derived from aromatic dicarboxylic acid, (C) a unit derived from aromatic amine, selected from aromatic diamine and aromatic amine containing a hydroxyl group, and (D) a unit derived from aromatic diol.

An example of the unit (A) (unit derived from aromatic hydroxycarboxylic acid) is a unit represented by a formula (a) below.

—O—Ar₁—CO— (a)

In the formula (a), Ar₁ represents 1,4-phenylene, 2,6-naphthalene, or 4,4′-biphenylene.

Ar₁ in the formula (a) may include a substituent. Accordingly, a phenylene ring, a naphthalene ring, and a biphenylene ring each may include a substituent. Examples of the substituent include one or more substituents selected from the group consisting of a halogen atom, an alkyl group, and an aryl group.

Representative examples of the unit (A) include a unit derived from p-hydroxybenzoic acid, a unit derived from 2-hydroxy-6-naphthoic acid, and a unit derived from 4-hydroxy-4′-biphenylcarboxylic acid. Among them, the unit derived from 2-hydroxy-6-naphthoic acid is preferably used.

Furthermore, an example of the unit (B) (unit derived from aromatic dicarboxylic acid) is a unit represented by a formula (b) below.

—CO—Ar₂—CO— (b)

In the formula (b), Ar₂ represents 1,4-phenylene, 1,3-phenylene, or 2,6-naphthalene.

Ar₂ in the formula (b) may include a substituent. Accordingly, a phenylene ring and a naphthalene ring each may include a substituent. Examples of the substituent include one or more substituents selected from the group consisting of a halogen atom, an alkyl group, and an aryl group.

Representative examples of the unit (B) include a unit derived from terephthalic acid, a unit derived from isophthalic acid, and a unit derived from 2,6-naphthalene dicarboxylic acid. Among them, the unit derived from isophthalic acid is preferably used.

An example of the unit (C) (unit derived from aromatic amine, selected from aromatic diamine and aromatic amine containing a hydroxyl group) is a unit represented by a formula (c) below.

—X—Ar₃—NH— (c)

In the formula (c), Ar₃ represents 1,4-phenylene, 1,3-phenylene, or 2,6-naphthalene, and X represents —O— or —NH—.

Ar₃ in the formula (c) may include a substituent. Accordingly, a phenylene ring and a naphthalene ring each may include a substituent. Examples of the substituent include one or more substituents selected from the group consisting of a halogen atom, an alkyl group, and an aryl group.

Representative examples of the unit (C) include a unit derived from 3-aminophenol, a unit derived from 4-aminophenol, a unit derived from 1,4-phenylenediamine, and a unit derived from 1,3-phenylenediamine. Among them, the unit derived from 4-aminophenol is preferably used.

An example of the unit (D) (unit derived from aromatic diol) is a unit represented by a formula (d) below.

—O—Ar₄—O— (d)

In the formula (d), Ar₄ represents 1,4-phenylene, 1,3-phenylene, or 4,4′-biphenylene.

Ar₄ in the formula (d) may include a substituent. Accordingly, a phenylene ring and a naphthalene ring each may include a substituent. Examples of the substituent include one or more substituents selected from the group consisting of a halogen atom, an alkyl group, and an aryl group.

Representative examples of the unit (D) include a unit derived from hydroquinone, a unit derived from resorcin, and a unit derived from 4,4′-biphenol. Among them, the unit derived from resorcin is preferably used.

In an embodiment of the present invention, aromatic polyester includes the above units (A) through (D) as constituent units. The composition of the aromatic polyester is such that the unit (A) is not less than 10 mol % and less than 30 mol %, the unit (B) is more than 35 mol % and not more than 45 mol %, and a sum of the unit (C) and the unit (D) is more than 35 mol % and not more than 45 mol % relative to 100 mol % in total number of moles of the units (A) through (D), and a molar ratio (D)/(C) of the unit (D) to the unit (C) is not more than 0.75.

Preferably, the composition of the aromatic polyester is such that the unit (A) is not less than 10 mol % and less than 20 mol %, the unit (B) is more than 40 mol % and not more than 45 mol %, and a sum of the unit (C) and the unit (D) is more than 40 mol % and not more than 45 mol % relative to 100 mol % in total number of moles of the units (A) through (D), and a molar ratio (D)/(C) of the unit (D) to the unit (C) is not more than 0.65. More preferably, the unit (D) is more than 0 mol % and less than 15 mol %.

In a case where the unit (A) is less than 10 mol %, there is a tendency that viscosity of the nonaqueous electrolyte secondary battery insulating porous layer increases rapidly in production of the nonaqueous electrolyte secondary battery insulating porous layer. In a case where the unit (A) is not less than 30 mol %, solubility of the nonaqueous electrolyte secondary battery insulating porous layer to a solvent drops.

In a case where the units (A) through (D) include a substituent, examples of the halogen atom include one or more atoms selected from the group consisting of a fluorine atom, a chlorine atom, a bromine atom etc.

Examples of the alkyl group include C1-C10 alkyl groups represented by a methyl group, an ethyl group, a propyl group, a butyl group etc. Examples of the aryl group include C6-C20 aryl groups represented by a phenyl group, a naphthyl group etc. The alkyl group and the aryl group each may be of a single type, or two or more types of the alkyl group or two or more types of the aryl group may be used.

In an embodiment of the present invention, the aromatic polyester includes the above units (A) through (D) as constituent units. The aromatic polyester can be produced in accordance with a common procedure disclosed in, for example, Japanese patent Application Publication No. 2002-220444, Japanese patent Application Publication No. 2002-146003, Japanese patent Application Publication No. 2006-199769 etc. with use of monomers corresponding to respective units, i.e. aromatic hydroxycarboxylic acid, aromatic dicarboxylic acid, aromatic amine, aromatic diol etc., or ester-forming derivatives and/or amide-forming derivatives thereof.

It is needless to say that mol % of the monomers used are substantially the same as those shown for the constituent units.

Examples of the ester-forming derivative or amide-forming derivative of carboxylic acid in aromatic dicarboxylic acid, aromatic hydroxycarboxylic acid etc. include (i) derivatives to which a carboxyl group has been changed and which have high reactivity and which accelerate a reaction of generating ester or amide (e.g. acid halide, acid anhydride), and (ii) derivatives to which a carboxyl group has been changed and which are esters of alcohols, ethyleneglycols etc. and which generate an ester via an ester exchange reaction and generate an amide via an amide exchange reaction.

An example of the ester-forming derivative of a phenolic hydroxyl group in aromatic diol, aromatic hydroxycarboxylic acid, amino phenol etc. is a derivative to which a phenolic hydroxyl group has been changed and which is an ester with lower carboxylic acids and which generates an ester via an ester exchange reaction.

An example of the amide-forming derivative of an amino group in aromatic diamine, amino phenol etc. is a derivative to which an amino group has been changed and which is an amide with lower carboxylic acids and which generates an amide via an amide exchange reaction.

In an embodiment of the present invention, an example of a representative method of producing aromatic polyester is a melt polymerization method in which a phenolic hydroxyl group and/or an amino group, such as aromatic hydroxycarboxylic acid, amino phenol, aromatic diamine, and aromatic diol, is acylated with an excessive amount of fatty acid anhydride to obtain an acylated compound, and an ester exchange and/or an amide exchange is carried out between the acylated compound thus obtained and a carboxyl group such as aromatic dicarboxylic acid and aromatic hydroxycarboxylic acid to carry out polycondensation.

In the acylation, an amount of fatty acid anhydride to be added is normally 1.0-1.2 times equivalent, and preferably 1.05-1.1 times equivalent, to a total of a phenolic hydroxyl group and an amino group. In a case where the amount of fatty acid anhydride to be added is less than 1.0 time equivalent, there is a tendency that an acylated compound, raw material monomers etc. are sublimated in polycondensation and the reaction system is likely to be blocked. In a case where the amount of fatty acid anhydride to be added is more than 1.2 times equivalent, there is a tendency that the aromatic polyester obtained colors.

The acylation is carried out normally at 130-180° C. for 5 minutes to 10 hours. The acylation is carried out more preferably at 140-160° C. for 10 minutes to 3 hours.

Examples of the fatty acid anhydride to be used in the acylation include, but are not particularly limited to, acetic anhydride, propionic anhydride, butyric anhydride, and isobutyric anhydride. Two or more of them may be used in combination. A more preferable example of the fatty acid anhydride is acetic anhydride in term of costs and handleability.

In the ester exchange and the amide exchange, it is preferable to adjust an amount of a carboxylic group to be 0.8-1.2 times equivalent to a total amount of an acyl group and an amide group.

The ester exchange and the amide exchange are carried out preferably at 130-400° C. with an increasing rate of 0.1-50° C./min., and more preferably at 150-350° C. with an increasing rate of 0.3-5° C./min. At that time, it is preferable to remove by-produced fatty acid and unreacted fatty acid anhydride to the outside of the system by evaporation etc. in order to move equilibrium.

The acylation, the ester exchange, and the amide exchange may be carried out in the presence of a catalyst. A catalyst having been conventionally and publicly known as one for polymerization of polyester may be used. Examples of the catalyst include (i) metal salt catalysts such as magnesium acetate, stannous acetate, tetrabutyl titanate, lead acetate, sodium acetate, potassium acetate, and antimony trioxide, and (ii) organic compound catalysts such as N,N-dimethyl aminopyridine and N-methyl imidazole.

Polycondensation by ester exchange and/or amide exchange is normally carried out by melt polymerization. Alternatively, polycondensation may be carried out by melt polymerization and solid phase polymerization in combination. Solid phase polymerization is carried out preferably in such a manner that polymer is extracted in a melt polymerization process and then the polymer is crushed into powder or flakes and then treated by a publicly known solid phase polymerization method. A specific example of the method is a method in which the polymer is heat-processed under inert gas atmosphere such as nitrogen at 180-350° C. in a solid phase for 1-30 hours.

The porous layer in accordance with an embodiment of the present invention may contain one type of a resin or a mixture of two or more types of resins. In a case of the mixture of two or more types of resins, the porous layer may contain two or more types of the above aromatic polyesters or may contain other resin as well as the above aromatic polyester(s).

<Other Resins>

The porous layer in accordance with an embodiment of the present invention may contain resin other than the aromatic polyester. Examples of the other resin, i.e. the resin other than the aromatic polyester encompass thermoplastic resins, examples of which encompass polyolefins such as polyethylene, polypropylene, polybutene, and an ethylene-propylene copolymer; fluorine-containing resins such as polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoro ethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer, and any of these fluorine-containing resins which is a fluorine-containing rubber having a glass transition temperature of equal to or less than 23° C.; aromatic polymers; polycarbonate; polyacetal; rubbers such as a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate; resins with a melting point or glass transition temperature of not lower than 180° C. such as polysulfone and polyester; water-soluble polymers such as polyvinyl alcohol, polyethylene glycol, cellulose ether, sodium alginate, polyacrylic acid, polyacrylamide, and polymethacrylic acid.

Among the aforementioned other resins, one type of a resin may be used or two or more types of resins may be used in combination.

It is preferable that these thermoplastic resins contained in the porous layer in accordance with an embodiment of the present invention are insoluble in an electrolyte of a nonaqueous electrolyte secondary battery and are electrochemically stable in a use range of the battery. Furthermore, the other resins are preferably aromatic polymers. Note that “aromatic polymer” herein refers to a polymer in which a structural unit constituting a main chain contains an aromatic ring. That is, “aromatic polymer” means that monomers which are a raw material of the thermoplastic resin contain aromatic compounds.

Specific examples of the aromatic polymer encompass aromatic polyamide, aromatic polyimide, aromatic polyester (aromatic polyester having a structural unit different from that of the above aromatic polyester in an embodiment of the present invention), aromatic polycarbonate, aromatic polysulfone, and aromatic polyether.

Preferable examples of the aromatic polymer encompass aromatic polyamide and aromatic polyimide in terms of high heat resistance. In terms of a similar matter, the aromatic polymer is preferably a wholly aromatic polymer in which a main chain has no aliphatic carbon. In terms of further increasing heat resistance of the porous layer in accordance with an embodiment of the present invention, the porous layer in accordance with an embodiment of the present invention preferably contains not only the aromatic polyester in an embodiment of the present invention but also the other resin which resin has high heat resistance.

Examples of the aromatic polyamide encompass: wholly aromatic polyamides such as para-aramid and meta-aramid; semi-aromatic polyamide; 6T nylon; 6I nylon; 8T nylon; 10T nylon; denatured 6T nylon; denatured 6I nylon; denatured 8T nylon; denatured 10T nylon; copolymers of these; and the like. Among them, para-aramid is preferable in terms of its high heat resistance.

Examples of a method of preparing the aromatic polyamide encompass, but are not particularly limited to, condensation polymerization of para-oriented aromatic diamine and para-oriented aromatic dicarboxylic acid halide. In such a case, aromatic polyamide to be obtained substantially includes repeating units in which amide bonds are bonded at para positions or corresponding oriented positions (for example, oriented positions that extend coaxially or parallel in opposite directions such as the cases of 4,4′-biphenylene, 1,5-naphthalene, and 2,6-naphthalene) of aromatic rings. Specific examples of the aromatic polyamide encompass para-aramids each having a para-oriented structure or a structure corresponding to a para-oriented structure, such as poly(paraphenylene terephthalamide), poly(parabenzamide), poly(4,4′-benzanilide terephthalamide), poly(paraphenylene-4,4′-biphenylene dicarboxylic acid amide), poly(paraphenylene-2,6-naphthalene dicarboxylic acid amide), poly(2-chloro-paraphenylene terephthalamide), and paraphenylene terephthalamide/2,6-dichloroparaphenylene terephthalamide copolymer.

The aromatic polyamide can be poly(paraphenylene terephthalamide) (hereinafter referred to as “PPTA”). A solution of the PPTA can be prepared by, for example, the following specific steps (1) through (4).

(1) N-methyl-2-pyrrolidone (hereinafter also referred to as “NMP”) is introduced into a flask which is dried. Then, calcium chloride, which has been dried at 200° C. for 2 hours, is added. Then, the flask is heated to 100° C. to completely dissolve the calcium chloride.
(2) A temperature of the solution obtained in the step (1) is returned to room temperature, and then paraphenylenediamine (hereinafter abbreviated as “PPD”) is added. Then, the PPD is completely dissolved.
(3) While a temperature of the solution obtained in the step (2) is maintained at 20±2° C., terephthalic acid dichloride (hereinafter referred to as “TPC”) is added in 10 separate portions at approximately 5-minute intervals.
(4) While a temperature of the solution obtained in the step (3) is maintained at 20±2° C., the solution is matured for 1 hour, and is then stirred under reduced pressure for 30 minutes to eliminate air bubbles, so that the solution of the PPTA is obtained.

The aromatic polyimide is preferably a wholly aromatic polyimide prepared through condensation polymerization of an aromatic dianhydride and an aromatic diamine. Specific examples of the aromatic dianhydride encompass pyromellitic dianhydride, 3,3′,4,4′-diphenyl sulfone tetracarboxylic dianhydride, 3,3′,4,4′-benzophenone tetracarboxylic dianhydride, 2,2′-bis(3,4-dicarboxyphenyl)hexafluoropropane, and 3,3′,4,4′-biphenyl tetracarboxylic dianhydride. Specific examples of the aromatic diamine encompass oxydianiline, paraphenylenediamine, benzophenone diamine, 3,3′-methylenedianiline, 3,3′-diaminobenzophenone, 3,3′-diaminodiphenyl sulfone, and 1,5′-naphthalene diamine. The aromatic dianhydride and the aromatic diamine are not limited to the above specific examples. In an embodiment of the present invention, polyimide soluble in a solvent can be used preferably. An example of such polyimide is a polyimide that is a polycondensate obtained from 3,3′,4,4′-diphenyl sulfone tetracarboxylic dianhydride and aromatic diamine.

<Ratio of Presence of Aromatic Polyester on Surface of Porous Layer>

In a case where the porous layer in accordance with an embodiment of the present invention contains resin other than the above aromatic polyester, a ratio of presence of the above aromatic polyester is preferably not less than 10 mol % relative to 100 mol % in total of the ratio of presence of the above aromatic polyester and a ratio of presence of the other resin on the surface of the porous layer.

The ratio of presence of the above aromatic polyester on the surface of the porous layer indicates a degree of uneven distribution of the above aromatic polyester on the surface of the porous layer. The degree of the uneven distribution being a predetermined value or more allows the porous layer in accordance with an embodiment of the present invention to have a more sufficiently high oxidation resistance. In terms of this point, the ratio of presence of the above aromatic polyester on the surface of the porous layer is preferably not less than 20 mol % and more preferably not less than 30 mol % relative to 100 mol % in total of the ratio of presence of the above aromatic polyester and the ratio of presence of the other resin on the surface. On the other hand, in a case where the ratio of presence of the above aromatic polyester is more than 90 mol %, although the porous layer has excellent oxidation resistance, there is a tendency that a porous layer structure is difficult to form, resulting in decrease in air permeability of the porous layer. Therefore, the ratio of presence of the aromatic polyester is preferably not more than 90 mol %.

A ratio of presence of the aromatic polyester on the surface of the porous layer can vary depending on production conditions for the porous layer. That is, in a case of using the aromatic polyester and the other resin in combination in order to obtain more sufficiently high oxidation resistance, it is necessary to optimize not only a ratio of mixing the aromatic polyester and the other resin but also the production conditions in order to adjust the ratio of presence of the aromatic polyester on the surface of the porous layer to be a preferred range.

The ratio of presence of the aromatic polyester on the surface of the porous layer can be obtained by a method below. Specifically, first, composition analysis is made on the surface of the porous layer with use of X-ray Photoelectron Spectroscopy (hereinafter referred to as “XPS”) and, based on an obtained spectrum, a peak area indicative of a binding energy of C1s (1s orbit of C) (hereinafter also referred to as “C1s peak area”) and a peak area indicative of a binding energy of N1s (1s orbit of N) (hereinafter also referred to as “N1s peak area”) are obtained.

XPS can be carried out, for example, in such a manner that AlKα X ray from a single crystal monochromator with a spot diameter of 800×400 μm (elliptic) is radiated to the surface of the porous layer (a range from the surface of the porous layer to a depth of 6-7 nm thereof) with use of a VG Thetaprobe system (manufactured by Thermo Fisher Scientific). Based on the obtained spectrum, the C1s peak area and the N1s peak area can be obtained.

In the present specification, the “surface” of the porous layer may be a range from the surface of the porous layer to a depth of 6-7 nm thereof. This is because in a case where an X ray is radiated to the porous layer with use of the system, the depth of the porous layer which depth is reached by the X ray is substantially covered by the above range, and accordingly exact measurement by XPS can be carried out within the above range.

Next, from the C1s peak area and the N1s peak area, an atomic percentage of C1s relative to a total atomic weight of Cis and N1 s (hereinafter referred to as “C1s atomic percentage”) is calculated. The C1s atomic percentage can be calculated in accordance with an equation 1 below.

C1s atomic percentage [atom %]=C1s peak area/peak area+N1s peak area) (1)

From the C1s atomic percentage thus calculated, the ratio of presence of the aromatic polyester on the surface of the porous layer is obtained as follows. First, measurement by XPS is carried out only for the aromatic polyester used in the porous layer and only for the other resin used in the porous layer. A C1s atomic percentage for the aromatic polyester and a C1s atomic percentage for the other resin are calculated in accordance with the above method. In a case of the porous layer made of the aromatic polyester only, the ratio of presence of the aromatic polyester on the surface of the porous layer is 100 mol %. In a case of the porous layer made of the other resin only, the ratio of presence of the aromatic polyester on the surface of the porous layer is 0%. Accordingly, the ratio of presence of the aromatic polyester on the surface of the porous layer (mixed porous layer) containing the aromatic polyester and the other resin can be calculated in accordance with an equation 2 below.

C1s atomic percentage of mixed porous layer=(C1s atomic percentage of aromatic polyester)×x %+(C1s atomic percentage of other resin)×(100−x)% (2)

The C1s atomic percentage of the mixed porous layer can be calculated from the result of measurement by XPS of the mixed porous layer in accordance with the equation 1. By assigning the C1s atomic percentage of the mixed porous layer, the C1s atomic percentage of the aromatic polyester, and the C1s atomic percentage of the other resin to the equation 2, it is possible to obtain the ratio of presence (x %) of the aromatic polyester on the surface of the mixed porous layer.

In a case where the aromatic polyester is a mixture of two or more types of polymers, a C1s atomic percentage obtained for the mixture is assigned to the equation 2. Similarly, in a case where the other resin is a mixture of two or more types of polymers, a C1s atomic percentage obtained for the mixture is assigned to the equation 2.

Oxidation resistance of the porous layer in a battery can be obtained by measuring a value of an oxidation current in cyclic voltammetry. The oxidation current serves as an index for oxidation in a battery. A higher value of the oxidation current indicates more advanced oxidation in a battery. Therefore, it can be considered that as the value of the oxidation current is lower, oxidation resistance of the porous layer in the battery is higher.

The oxidation current can be measured by, for example, a method below. Specifically, the porous layer or the nonaqueous electrolyte secondary battery laminated separator in accordance with an embodiment of the present invention is sandwiched by an SUS plate to which Li foil has been attached and an SUS plate evaporated with gold, and an electrolyte is poured so that a coin cell is prepared. Next, a voltage based on Li reference is applied on the surface of the porous layer, and a current flowing therethrough is measured. Thus, the oxidation current can be measured.

In later-mentioned Examples, five cycles of cyclic voltammetry were carried out, and a current value at 4.5 V in the first cycle was measured and regarded as a measured value of the oxidation current. In this case, in terms of obtaining sufficient oxidation resistance, the oxidation current is preferably not more than 115 μA, not more than 110 μA, not more than 105 μA, and not more than 100 μA. The oxidation current is more preferable as it is lower.

<Inorganic Filler>

The porous layer in accordance with an embodiment of the present invention may further include inorganic filler. The inorganic filler is insulating, and can be made of inorganic powder.

Examples of the inorganic powder encompass powders made of inorganic matters such as a metal oxide, a metal nitride, a metal carbide, a metal hydroxide, a carbonate, and a sulfate. Specific examples of the inorganic powder encompass powders made of inorganic matters such as alumina, silica, titanium dioxide, aluminum hydroxide, and calcium carbonate. The filler can be made of one of these inorganic powders, or can be made of two or more of these inorganic powders mixed.

Among these inorganic powders, an alumina powder is preferable in view of chemical stability. It is more preferable that particles by which the inorganic filler is constituted be all alumina particles. It is a still more preferable embodiment that (i) the particles by which the inorganic filler is constituted are all alumina particles and (ii) all or part of the alumina particles are substantially spherical alumina particles. Note that in an embodiment of the present invention, the substantially spherical alumina particles include absolutely spherical particles.

According to an embodiment of the present invention, in a case where, for example, the particles by which the inorganic filler is constituted are all alumina particles, a weight of the inorganic filler relative to a total weight of the porous layer in accordance with an embodiment of the present invention is ordinarily 20% by weight to 95% by weight, and preferably 30% by weight to 90% by weight, although an inorganic filler content of the porous layer depends on a specific gravity of the material of the inorganic filler. The above ranges can be set as appropriate according to the specific gravity of the material of the inorganic filler.

Examples of a shape of the inorganic filler in accordance with an embodiment of the present invention encompass a substantially spherical shape, a plate-like shape, a pillar shape, a needle shape, a whisker-like shape, a fibrous shape, and the like. Although any particle can be used to constitute the inorganic filler, substantially spherical particles are preferable because substantially spherical particles allow uniform pores to be easily made. In view of a strength property and smoothness of the porous layer, an average particle diameter of particles by which the inorganic filler is constituted is preferably 0.01 μm to 1 μm. Note that the average particle diameter is to be indicated by a value measured with the use of a photograph taken by a scanning electron microscope. Specifically, any 50 particles of particles captured in the photograph are selected, respective particle diameters of the 50 particles are measured, and then an average value of the particle diameters thus measured is used as the average particle diameter.

<Physical Properties of Porous Layer>

In a case where the porous layer is disposed on both surfaces of a porous base material, the physical properties in the following description regarding physical properties of the porous layer refers to at least physical properties of a porous layer disposed on a surface of the porous base material which surface faces a cathode of the nonaqueous electrolyte secondary battery.

In a case where a porous layer is disposed on one surface or both surfaces of the porous base material, a thickness of the porous layer is preferably 0.5 μm to 15 μm (per surface of the porous film), and more preferably 2 μm to 10 μm (per surface of the porous film), although the thickness of the porous layer can be decided as appropriate in view of a thickness of a nonaqueous electrolyte secondary battery laminated separator to be produced.

The thickness of the porous layer is preferably not less than 1 μm (not less than 0.5 μm per surface of the porous film). This is because, with such a thickness, (i) an internal short circuit of the battery, which internal short circuit is caused by breakage or the like of the battery, can be sufficiently prevented in a nonaqueous electrolyte secondary battery laminated separator which includes the porous layer and (ii) an amount of an electrolyte retained in the porous layer can be maintained.

Meanwhile, a total thickness of both the surfaces of the porous layer is preferably not more than 30 μm (not more than 15 μm per surface of the porous film). This is because, with such a thickness, (i) it is possible to restrict an increase in resistance to permeation of ions such as lithium ions all over the nonaqueous electrolyte secondary battery laminated separator which includes the porous layers, (ii) it is possible to prevent the cathode from deteriorating in a case where a charge-discharge cycle is repeated, so that a rate characteristic and/or a cycle characteristic is/are prevented from deteriorating, and (iii) an increase in distance between the cathode and an anode is restricted, so that the nonaqueous electrolyte secondary battery can be prevented from being large in size.

<Porous Layer Production Method>

The porous layer in accordance with an embodiment of the present invention can be produced by, for example, (i) dissolving the aromatic polyester in a solvent and, optionally, dissolving the other resin in the solvent and, further optionally, dispersing the inorganic filler in the solvent, so as to prepare a coating solution for forming a porous layer and then (ii) coating a base material with the coating solution and then drying the coating solution, so as to deposit the porous layer in accordance with an embodiment of the present invention. Examples of the base material encompass (i) a porous base material described later, (ii) an electrode, and (iii) the like.

The solvent (dispersion medium) is not limited to any particular one, provided that (i) the solvent does not have an adverse effect on the base material, (ii) the solvent allows the aromatic polyester and the other resin to be uniformly and stably dissolved in the solvent, (iii) the solvent allows the inorganic filler to be uniformly and stably dispersed in the solvent. Specific examples of the solvent (dispersion medium) preferably encompass non-protic polar solvents such as N-methylpyrrolidone, N,N-dimethylacetamide, N,N dimethylformamide, acetonitrile, dimethylsulfoxide, and tetrahydrofuran. In terms of segregation of the aromatic polyester on the surface of the other resin, the non-protic polar solvents more preferably contain a nitrogen element. Only one of these solvents (dispersion media) can be used, or two or more of these solvents (dispersion media) can be used in combination.

The coating solution can be formed by any method, provided that the coating solution can satisfy conditions such as a resin solid content (resin concentration) and an amount of the inorganic filler, each of which conditions is necessary to obtain a desired porous layer. Specific examples of the method encompass a method in which an inorganic filler is added to and dispersed in a solution which is obtained by dissolving the aromatic polyester and the other resin in a solvent (dispersion medium). In a case where the inorganic filler is added, the inorganic filler can be dispersed in a solvent (dispersion medium) with the use of a conventionally and publicly known dispersing device, examples of which encompass a three-one motor, a homogenizer, a medium type dispersing device, a pressure type dispersing device, and the like.

The resin concentration is preferably in a range of not less than 4 wt % and not more than 20 wt %. In the case of containing the other resin, the resin concentration is preferably in a range of not less than 4 wt % and not more than 20 wt %, and more preferably not less than 5 wt % and not more than 15 wt %, in terms of segregation of the aromatic polyester on the surface of the other resin.

In a case where the resin concentration is less than 4 wt %, a deposition speed of the resin in a later-mentioned solvent removal step is low, so that deposition behaviors of individual resins hardly differ. This results in difficulty in segregation. On the other hand, in a case where the resin concentration is more than 20 wt %, the deposition speed of the resin is high, so that deposition behaviors of individual resins hardly differ similarly with the case where the resin concentration is low, and so this case is not preferable. Furthermore, since this case causes high viscosity of the coating solution, this case is not preferable also in terms of operability and stability in storage of the coating solution.

A method of coating the base material with the coating solution encompass publicly known coating methods such as a knife coater method, a blade coater method, a bar coater method, a gravure coater method, and a die coater method.

A method of removing the solvent (dispersion medium) is generally a drying method. Examples of the drying method encompass natural drying, air-blowing drying, heat drying, drying under reduced pressure, and the like. Note, however, that any method can be used, provided that the solvent (dispersion medium) can be sufficiently removed. In addition, drying can be carried out after the solvent (dispersion medium) contained in the coating solution is replaced with another solvent. Specific examples of the method, in which the solvent (dispersion medium) is replaced with another solvent and then drying is carried out, encompass a method in which (i) the solvent (dispersion medium) is replaced with a poor solvent having a low boiling point, such as water, alcohol, or acetone, (ii) the porous layer is deposited, and then (iii) the drying is carried out.

In the case of containing the other resin, it is preferable that the solvent is replaced with water in humidification, in terms of segregation of the aromatic polyester on the surface of the other resin. Humidification conditions are preferably such that a relative humidity is not less than 30% and not more than 95%, and more preferably such that the relative humidity is not less than 45% and not more than 90%.

In a case where the relative humidity is less than 30%, the deposition speed of a resin is low, so that deposition behaviors of individual resins hardly differ. This results in difficulty in segregation. On the other hand, in a case where the relative humidity is more than 95%, deposition of the resin occurs only on the uppermost surface of the porous layer, so that replacement of the solvent with water and removal of the solvent from the porous layer are prevented. Consequently, deposition behaviors of individual resins hardly differ.

### Embodiment 2: Nonaqueous Electrolyte Secondary Battery Laminated Separator

A nonaqueous electrolyte secondary battery laminated separator in accordance with Embodiment 2 of the present invention includes (i) a porous base material containing a polyolefin-based resin as a main component and (ii) a porous layer in accordance with Embodiment 1 of the present invention which porous layer is disposed on at least one surface of the porous base material.

<Porous Base Material>

The porous base material can be a porous film containing a polyolefin-based resin as a main component (herein also referred to as “porous film”). The porous film is preferably a microporous film. Specifically, the porous film preferably has pores therein, the pores being connected to one another, so that a gas or a liquid can pass through the porous film from one surface of the porous film to the other. The porous film can include a single layer or a plurality of layers.

The “porous film containing a polyolefin-based resin as a main component” herein means that a polyolefin-based resin component is contained in the porous film at a proportion of ordinarily not less than 50% by volume, preferably not less than 90% by volume, and more preferably not less than 95% by volume of an entire portion of a material of the porous film.

The polyolefin-based resin preferably contains a high molecular weight component having a weight-average molecular weight of 5×10⁵ to 15×10⁶. It is preferable that a polyolefin-based resin having a weight-average molecular weight of not less than 1,000,000 be contained as a polyolefin-based resin in the porous film. This is because, in such a case, there can be an increase in strength of an entire portion of a nonaqueous electrolyte secondary battery laminated separator.

Examples of the polyolefin-based resin encompass high molecular weight homopolymers (such as polyethylene, polypropylene, and polybutene) and high molecular weight copolymers (such as ethylene-propylene copolymer) produced through polymerization of ethylene, propylene, 1-butene, 4-methyl-1-pentene, 1-hexene or the like.

The porous film is a layer which includes one of these polyolefin-based resins and/or two or more of these polyolefin-based resins. A high molecular weight polyethylene-based resin containing ethylene as a main component is particularly preferable in view of the fact that such a polyethylene-based resin can prevent (shutdown) the flow of an excessively large current at a low temperature. Note that the porous film can contain any component other than the polyolefin-based resin, provided that the component does not impair the function of the porous film.

Air permeability of the porous film in terms of Gurley values is ordinarily 30 sec/100 cc to 500 sec/100 cc, and preferably 50 sec/100 cc to 300 sec/100 cc. If the air permeability of the porous film falls within these ranges, sufficient ion permeability can be imparted to a nonaqueous electrolyte secondary battery laminated separator in a case where the porous film is used as a member of the nonaqueous electrolyte secondary battery laminated separator.

In regard to a thickness of the porous film, a less thickness can cause energy density of the battery to be higher. Therefore, the thickness of the porous film is preferably not more than 20 μm, more preferably not more than 16 μm, and still more preferably not more than 11 μm. In view of film strength, the thickness of the porous film is preferably not less than 4 μm. That is, the thickness of the porous film is preferably 4 μm to 20 μm.

A method of producing the porous film can be any publicly known method, and is not limited to any particular one. For example, as disclosed in Japanese Patent No. 5476844, the porous film can be produced by (i) adding a filler to a thermoplastic resin, (ii) forming, into a film, the thermoplastic resin containing the filler, and then (iii) removing the filler.

Specifically, in a case where, for example, the porous film is made of polyolefin resin containing ultra-high molecular weight polyethylene and low molecular weight polyolefin which has a weight-average molecular weight of not more than 10,000, the porous film is preferably produced by, in view of production costs, a method including the following steps (1) through (4):

(1) kneading 100 parts by weight of ultra-high molecular weight polyethylene, 5 parts by weight to 200 parts by weight of low molecular weight polyolefin having a weight-average molecular weight of not more than 10,000, and 100 parts by weight to 400 parts by weight of an inorganic filler such as calcium carbonate, so that a polyolefin resin composition is obtained;
(2) forming the polyolefin resin composition into a sheet;
(3) removing the inorganic filler from the sheet obtained in the step (2); and
(4) stretching the sheet obtained in the step (3).
Alternatively, the porous film can be produced through a method disclosed in the above-described Patent Literature.

Alternatively, the porous film can be a commercial product having the above-described characteristics.

<Nonaqueous Electrolyte Secondary Battery Laminated Separator Production Method>

The nonaqueous electrolyte secondary battery laminated separator in accordance with an embodiment of the present invention can be produced by, for example, a method in which the porous film containing the polyolefin as a main component is used as a base material in the above-described method of producing the porous layer in accordance with an embodiment of the present invention.

<Physical Properties of Nonaqueous Electrolyte Secondary Battery Laminated Separator>

In regard to a thickness of the nonaqueous electrolyte secondary battery laminated separator in accordance with an embodiment of the present invention, a less thickness can allow energy density of the battery to be higher, and is therefore preferable. However, a less thickness also leads to less strength, and there is therefore a limitation on a reduction in the thickness during production of the nonaqueous electrolyte secondary battery laminated separator. In view of these factors, the nonaqueous electrolyte secondary battery laminated separator has a thickness of preferably not more than 50 μm, more preferably not more than 25 μm, and still more preferably not more than 20 μm. In addition, the nonaqueous electrolyte secondary battery laminated separator preferably has a thickness of not less than 5 μm.

Piercing strength of the nonaqueous electrolyte secondary battery laminated separator in accordance with an embodiment of the present invention is preferably not less than 4.6 N and more preferably not less than 4.7 N.

Piercing strength (Sp) of the nonaqueous electrolyte secondary battery laminated separator in accordance with an embodiment of the present invention is measured by a method including the step (i) below.

(i) The nonaqueous electrolyte secondary battery laminated separator is fixed by a washer of 12 mmΦ and pierced by a pin (pin diameter: 1 mmΦ, end point: 0.5R) at a rate of 200 mm/min from a porous layer side of the nonaqueous electrolyte secondary battery laminated separator. Maximum stress (gf) at the time of piercing is measured, and the measured value is regarded as piercing strength (Sp) of the nonaqueous electrolyte secondary battery laminated separator.

### Embodiment 3: Nonaqueous Electrolyte Secondary Battery Member, Embodiment 4: Nonaqueous Electrolyte Secondary Battery

A nonaqueous electrolyte secondary battery member in accordance with Embodiment 3 of the present invention is obtained by arranging a cathode, the porous layer in accordance with Embodiment 1 of the present invention or the nonaqueous electrolyte secondary battery laminated separator in accordance with Embodiment 2 of the present invention, and an anode, the cathode, the porous layer or the nonaqueous electrolyte secondary battery laminated separator, and the anode being arranged in this order.

A nonaqueous electrolyte secondary battery in accordance with Embodiment 4 of the present invention includes (i) the porous layer in accordance with Embodiment 1 of the present invention or (ii) the nonaqueous electrolyte secondary battery laminated separator in accordance with Embodiment 2 of the present invention.

Furthermore, a nonaqueous electrolyte secondary battery in accordance with an embodiment of the present invention can be a lithium ion secondary battery including the nonaqueous electrolyte secondary battery member. Note that constituent elements, other than the porous layer, of the nonaqueous electrolyte secondary battery are not limited to those described below.

The nonaqueous electrolyte secondary battery in accordance with an embodiment of the present invention is ordinarily configured so that a battery element is enclosed in an exterior member, the battery element including (i) a structure in which the anode and the cathode faces each other via the porous layer in accordance with an embodiment of the present invention or the nonaqueous electrolyte secondary battery laminated separator in accordance with an embodiment of the present invention and (ii) an electrolyte with which the structure is impregnated. The nonaqueous electrolyte secondary battery is preferably a secondary battery including a nonaqueous electrolyte, and is particularly preferably a lithium ion secondary battery. Note that the doping means occlusion, support, adsorption, or insertion, and means a phenomenon in which lithium ions enter an active material of an electrode (e.g., a cathode).

The nonaqueous electrolyte secondary battery member in accordance with an embodiment of the present invention and the nonaqueous electrolyte secondary battery in accordance with an embodiment of the present invention include the porous layer in accordance with an embodiment of the present invention or the nonaqueous electrolyte secondary battery laminated separator in accordance with an embodiment of the present invention. Accordingly, the nonaqueous electrolyte secondary battery member in accordance with an embodiment of the present invention and the nonaqueous electrolyte secondary battery in accordance with an embodiment of the present invention can exhibit excellent oxidation resistance in a battery, and enables air permeability engaged with battery characteristics to be kept in a preferable range.

<Cathode>

A cathode included in the nonaqueous electrolyte secondary battery member in accordance with an embodiment of the present invention or included in the nonaqueous electrolyte secondary battery in accordance with an embodiment of the present invention is not limited to any particular one, provided that the cathode is one that is typically used as a cathode of a nonaqueous electrolyte secondary battery. Examples of the cathode encompass a cathode sheet having a structure in which an active material layer containing a cathode active material and a binder resin is formed on a current collector. The active material layer can further contain an electrically conductive agent.

The cathode active material is, for example, a material capable of being doped with and dedoped of lithium ions. Specific examples of such a material encompass a lithium complex oxide containing at least one transition metal such as V, Mn, Fe, Co, or Ni.

Examples of the electrically conductive agent encompass carbonaceous materials such as natural graphite, artificial graphite, cokes, carbon black, pyrolytic carbons, carbon fiber, a fired product of an organic polymer compound, and the like. It is possible to use (i) only one kind of the above electrically conductive agents or (ii) two or more kinds of the above electrically conductive agents in combination.

Examples of the binding agent encompass (i) fluorine-based resins such as polyvinylidene fluoride, (ii) acrylic resin, and (iii) styrene butadiene rubber. Note that the binding agent serves also as a thickener.

Examples of the cathode current collector encompass electric conductors such as Al, Ni, and stainless steel. Among these, Al is preferable because Al is easily processed into a thin film and is inexpensive.

Examples of a method of producing the cathode sheet encompass: (I) a method in which a cathode active material, an electrically conductive agent, and a binding agent are pressure-molded on a cathode current collector; (II) a method in which (i) a cathode active material, an electrically conductive agent, and a binding agent are formed into a paste with the use of a suitable organic solvent, (ii) a cathode current collector is coated with the paste, and then (iii) the paste is dried and then pressured so that the paste is firmly fixed to the cathode current collector; and (III) the like.

<Anode>

An anode included in the nonaqueous electrolyte secondary battery member in accordance with an embodiment of the present invention or included in the nonaqueous electrolyte secondary battery in accordance with an embodiment of the present invention is not limited to any particular one, provided that the anode is one that is typically used as an anode of a nonaqueous electrolyte secondary battery. Examples of the anode encompass an anode sheet having a structure in which an active material layer containing an anode active material and a binder resin is formed on a current collector. The active material layer can further contain an electrically conductive auxiliary agent.

Examples of the anode active material encompass (i) a material capable of being doped with and dedoped of lithium ions, (ii) lithium metal, and (iii) lithium alloy. Examples of such a material encompass carbonaceous materials such as natural graphite, artificial graphite, cokes, carbon black, and pyrolytic carbon.

The anode current collector is exemplified by Cu, Ni, stainless steel, and the like, among which Cu is more preferable because Cu is not easily alloyed with lithium especially in the case of a lithium ion secondary battery and is easily processed into a thin film.

Examples of a method of producing the anode sheet encompass: a method in which an anode active material is pressure-molded on an anode current collector; and a method in which (i) an anode active material is formed into a paste with the use of a suitable organic solvent, (ii) an anode current collector is coated with the paste, and then (iii) the paste is dried and then pressured so that the paste is firmly fixed to the anode current collector. The paste preferably contains the electrically conductive auxiliary agent and the binding agent.

<Nonaqueous Electrolyte>

A nonaqueous electrolyte in a nonaqueous electrolyte secondary battery in accordance with an embodiment of the present invention is not limited to any particular one, provided that the nonaqueous electrolyte is one that is typically used for a nonaqueous electrolyte secondary battery. The nonaqueous electrolyte can be one prepared by dissolving a lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, LiAlCl₄, and the like. It is possible to use (i) only one kind of the above lithium salts or (ii) two or more kinds of the above lithium salts in combination.

Examples of the organic solvent to be contained in the nonaqueous electrolyte encompass carbonates, ethers, esters, nitriles, amides, carbamates, a sulfur-containing compound, a fluorine-containing organic solvent obtained by introducing a fluorine group into any of these organic solvents, and the like. It is possible to use (i) only one kind of the above organic solvents or (ii) two or more kinds of the above organic solvents in combination.

<Nonaqueous Electrolyte Secondary Battery Member Production Method and Nonaqueous Electrolyte Secondary Battery Production Method>

A nonaqueous electrolyte secondary battery member in accordance with an embodiment of the present invention can be produced by, for example, arranging a cathode, a porous layer in accordance with an embodiment of the present invention or a nonaqueous electrolyte secondary battery laminated separator in accordance with an embodiment of the present invention, and an anode in this order.

A nonaqueous electrolyte secondary battery in accordance with an embodiment of the present invention can be produced by, for example, (i) forming a nonaqueous electrolyte secondary battery member by the method described above, (ii) placing the nonaqueous electrolyte secondary battery member in a container which is to serve as a housing of the nonaqueous electrolyte secondary battery, (iii) filling the container with a nonaqueous electrolyte, and then (iv) hermetically sealing the container under reduced pressure.

### EXAMPLES

[Measuring Method]

Physical property values of nonaqueous electrolyte secondary battery laminated separators produced in Examples 1 through 5 and Comparative Example 1 were measured as follows.

(1) Measurement by XPS

Composition analysis was made on the surface of the porous layer of the nonaqueous electrolyte secondary battery laminated separator with use of XPS, and based on an obtained spectrum, a C1s peak area and a N1s peak area were obtained.

Measurement was carried out with use of VG Thetaprobe system (manufactured by Thermo Fisher Scientific) in such a manner that AlKα X ray from a single crystal monochromator with a spot diameter of 800×400 μm (elliptic) was radiated to the surface of the porous layer (a range from the surface of the porous layer to a depth of 6-7 nm thereof). Based on the obtained spectrum, the C1s peak area and the N1s peak area were obtained.

Next, from the C1s peak area and the N1s peak area, an atomic percentage of C1s relative to a total atomic weight of C1s and N1s (C1s atomic percentage) was calculated in accordance with the aforementioned equation 1.

From the C1s atomic percentage thus calculated, the ratio of presence of the aromatic polyester on the surface of the porous layer was obtained as follows. First, measurement by XPS was carried out only for an aromatic polyester 1 (specifically, polymer B1 used in later-mentioned Examples) used in the porous layer and only for the other resin 2 (specifically, para-aramid) used in the porous layer. A C1s atomic percentage for the aromatic polyester 1 and a C1s atomic percentage for the other resin 2 (para-aramid) were calculated in accordance with the above method. Then, the ratio of presence of the aromatic polyester 1 on the surface of the porous layer (mixed porous layer) containing the aromatic polyester 1 and the other resin 2 was calculated in accordance with the aforementioned equation 2.

The C1s atomic percentage of the mixed porous layer was calculated from the result of XPS measurement of the mixed porous layer in accordance with the equation 1. The C1s atomic percentage of the mixed porous layer, the C1s atomic percentage of the aromatic polyester 1, and the C1s atomic percentage of the other resin 2 (para-aramid) were assigned to the equation 2, and the ratio of presence (x %) of the aromatic polyester 1 on the surface of the mixed porous layer was obtained.

### (2) Measurement by Cyclic Voltammetry

The nonaqueous electrolyte secondary battery laminated separator was cut to have a disc-shape of φ17 mm, and then was sandwiched by (i) an SUS plate of 0.5 mm in thickness and φ15.5 mm to which Li foil of the same size had been attached and (ii) an SUS plate evaporated with gold in advance.

Then, an electrolyte was poured so that a bipolar coin cell (CR2032 type) was prepared. The electrolyte was 1M LiPF₆ EC/EMC/DEC=3/5/2 (volume ratio). The coin cell thus prepared was placed in a temperature-controlled bath (temperature in bath: 25° C.), and subjected to five cycles of cyclic voltammetry with use of a cell test system (1470E, manufactured by Solartron) in a measurement voltage range of 3V-5V at a sweep rate of 5 mV/s, and a current value at 4.5 V in the first cycle was measured.

(3) Piercing Strength

Piercing strength (Sp) of the nonaqueous electrolyte secondary battery laminated separator was measured by a method including the step (i) below.

(i) The nonaqueous electrolyte secondary battery laminated separator was fixed by a washer of 12 mmΦ and pierced by a pin (pin diameter: 1 mmΦ, end point: 0.5R) at a rate of 200 mm/min from a porous layer side of the nonaqueous electrolyte secondary battery laminated separator. Maximum stress (N) at the time of piercing was measured, and the measured value was regarded as piercing strength (Sp) of the nonaqueous electrolyte secondary battery laminated separator.

### Example 1

<Preparation of Para-Aramid Solution>

PPTA was synthesized with the use of a 5-liter (1) separable flask having a stirring blade, a thermometer, a nitrogen incurrent canal, and a powder addition port.

The separable flask was sufficiently dried, and then 4200 g of NMP was introduced into the separable flask. Then, 272.65 g of calcium chloride, which had been dried at 200° C. for 2 hours, was added, and then a temperature inside the separable flask was increased to 100° C. After the calcium chloride was completely dissolved, the temperature inside the flask was returned to room temperature, and then 132.91 g of paraphenylenediamine (hereinafter abbreviated as “PPD”) was added. Then, the PPD was completely dissolved, so that a solution was obtained. While a temperature of the solution was maintained at 20±2° C., 243.32 g of a terephthalic acid dichloride (hereinafter abbreviated as “TPC”) was added, to the solution, in ten separate portions at approximately 5-minute intervals.

Then, while a temperature of the resultant solution was maintained at 20±2° C., the solution was matured for 1 hour. Then, the solution was stirred under reduced pressure for 30 minutes to eliminate air bubbles, so that a PPTA solution (polymer solution) was obtained. Part (as a sample) of the polymer solution was reprecipitated with the use of water, and was then extracted as a polymer, so that PPTA was obtained. Then, intrinsic viscosity of the PPTA thus obtained was measured, and was 1.97 dl/g. The PPTA solution thus obtained will be referred to as “solution A1”, and the PPTA thus obtained will be referred to as “polymer A”.

<Synthesis of Aromatic Polyester>

Into a reactor including a stirring apparatus, a torque meter, a nitrogen gas inlet tube, a thermometer, and a reflux condenser, 248.6 g (1.8 mol) of 4-hydroxybenzoic acid, 468.6 g (3.1 mol) of 4-hydroxyacetanilide, 681.1 g (4.1 mol) of isophthalic acid, 110.1 g (1.0 mol) of hydrochinone, and 806.5 g (7.90 mol) of acetic anhydride were introduced. Then, a gas inside the reactor was sufficiently replaced with a nitrogen gas, and then a temperature inside the reactor was increased to 150° C. under a nitrogen gas airflow over a period of 15 minutes. Then, while the temperature (150° C.) was maintained, a reaction solution was refluxed for 3 hours.

Then, while an acetic acid distilled as a byproduct and an unreacted acetic anhydride were distilled away, the temperature was increased to 300° C. over a period of 300 minutes. At a time point at which an increase in torque was observed, it was determined that a reaction had ended. Then, a resultant content was extracted. The resultant content was cooled to room temperature, and then was crushed with the use of a crusher. Then, an aromatic polyester powder having a relatively low molecular weight was obtained. Then, a temperature, at which the aromatic polyester powder started flowing, was measured with the use of a flow tester “Model CFT-500” manufactured by Shimadzu Corporation, and was 253.2° C. Furthermore, the aromatic polyester powder was subjected to solid phase polymerization by being subjected to a heat treatment at 290° C. in a nitrogen atmosphere for 3 hours.

100 g of the obtained liquid crystalline polyester was added to 400 g of N-methyl-2-pyrrolidone, and then a resultant mixture was heated at 100° C. for 2 hours, so that a liquid composition was obtained. Then, viscosity of the liquid composition was measured at a temperature of 23° C. with the use of a B-type viscometer “Model TVL-20” (Rotor No. 22, rotation speed: 20 rpm) manufactured by Toki Sangyo Co. Ltd., and was 3000 cP. The wholly aromatic polyester solution thus obtained will be referred to as “solution B1”, and the wholly aromatic polyester thus obtained will be referred to as “polymer B1”.

<Preparation of Coating Solution>

The solution A1 containing 150 parts by weight of the polymer A and the solution B1 containing 50 parts by weight of the polymer B1 were mixed to form a mixed solution so that a molar ratio of the polymer A to the polymer B1, (polymer A):(polymer B1), would be 75 mol %: 25 mol %. Then, 400 parts by weight of an alumina powder having an average particle size of 0.02 μm and 400 parts by weight of an alumina powder having an average particle size of 0.3 μm were added to the mixed solution. Then, a resultant mixture was diluted with NMP so that a solid content concentration would be 7%. Then, the resultant mixture was stirred with the use of a homogenizer, and was then treated twice at 50 MPa with the use of a pressure type dispersing device, so that a coating solution 1 was obtained.

<Production of Nonaqueous Electrolyte Secondary Battery Laminated Separator>

A PE separator base material (air permeability: 120 seconds/100 cc, thickness: 15 μm) was attached to a glass plate. Then, with the use of a bar coater manufactured by Tester Sangyo Co., Ltd., a surface (one surface) of the PE separator base material was coated with the coating solution 1. Then, the resultant coated product was placed, for 1 minute, in a humidifying oven having a relative humidity of 80% at 60° C., was washed with the use of ion exchange water, and was then dried with the use of an oven at 80° C., so that a nonaqueous electrolyte secondary battery laminated separator 1 was obtained. Piercing strength of the nonaqueous electrolyte secondary battery laminated separator 1 was 4.7 N.

### Example 2

A nonaqueous electrolyte secondary battery laminated separator 2 was obtained by a method similar to the method described in Example 1 except that (i) the solution A1 containing 124 parts by weight of the polymer A and the solution B1 containing 76 parts by weight of the polymer B1 were mixed so that the molar ratio of the polymer A to the polymer B1, (polymer A):(polymer B1), as described in Example 1 was changed to 62 mol %: 38 mol % in preparing a coating solution and (ii) a resultant mixture was diluted with NMP so that a solid content concentration would be 8%. Piercing strength of the nonaqueous electrolyte secondary battery laminated separator 2 was 4.7 N.

### Example 3

A nonaqueous electrolyte secondary battery laminated separator 3 was obtained by a method similar to the method described in Example 1 except that (i) the solution A1 containing 100 parts by weight of the polymer A and the solution B1 containing 100 parts by weight of the polymer B1 were mixed so that the molar ratio of the polymer A to the polymer B1, (polymer A):(polymer B1), as described in Example 1 was changed to 50 mol %: 50 mol % in preparing a coating solution and (ii) a resultant mixture was diluted with NMP so that a solid content concentration would be 9%. Piercing strength of the nonaqueous electrolyte secondary battery laminated separator 3 was 4.9 N.

### Example 4

A nonaqueous electrolyte secondary battery laminated separator 4 was obtained by a method similar to the method described in Example 1 except that (i) the solution A1 containing 80 parts by weight of the polymer A and the solution B1 containing 120 parts by weight of the polymer B1 were mixed so that the molar ratio of the polymer A to the polymer B1, (polymer A):(polymer B1), as described in Example 1 was changed to 40 mol %: 60 mol % in preparing a coating solution and (ii) a resultant mixture was diluted with NMP so that a solid content concentration would be 10%. Piercing strength of the nonaqueous electrolyte secondary battery laminated separator 4 was 5.0 N.

### Example 5

A nonaqueous electrolyte secondary battery laminated separator 5 was obtained by a method similar to the method described in Example 1 except that the solution B1 containing 200 parts by weight of the polymer B1 was used as the coating solution and then diluted with NMP so that a solid concentration was 10%. Piercing strength of the nonaqueous electrolyte secondary battery laminated separator 5 was 5.3 N.

### Comparative Example 1

A nonaqueous electrolyte secondary battery laminated separator 6 was obtained by a method similar to the method described in Example 1 except that the solution A1 containing 200 parts by weight of the polymer A was used as the coating solution and then diluted with NMP so that a solid concentration was 6%. Piercing strength of the nonaqueous electrolyte secondary battery laminated separator 6 was 4.5 N.

The following Table 1 shows the respective physical property values of the nonaqueous electrolyte secondary battery laminated separators produced in Examples 1 through 5 and Comparative Example 1.

TABLE 1

| | | | | | | Effect of the invention | |
|---|---|---|---|---|---|---|---|
| | | | | | | Cyclic | |
| | | | | Ratio of presence of resin | | voltammetry | |
| | Condition for | Result of XPS | | on surface of porous layer | | (first cycle, | |
| | porous layer | measurement | | (result of calculation) | | 4.5 V) | |
| | Ratio of | (atomic percentage) | | | Aromatic | Oxidation | Piercing |
| | introducing | C1s | N1s | Aramid | polyester | current value | strength |
| | aromatic polyester | [atom. %] | [atom. %] | [mol %] | [mol %] | [μA] | [N] |
| Ex. 1 | 25 | 90.5 | 9.5 | 70 | 30 | 97 | 4.7 |
| Ex. 2 | 38 | 93.6 | 6.4 | 31 | 69 | 101 | 4.7 |
| Ex. 3 | 50 | 93.5 | 6.5 | 33 | 68 | 104 | 4.9 |
| Ex. 4 | 60 | 94.7 | 5.3 | 17 | 83 | 73 | 5.0 |
| Ex. 5 | 100 | 96.1 | 3.9 | 0.0 | 100 | 68 | 5.3 |
| Com. Ex. 1 | 0 | 88.1 | 11.9 | 100 | 0.0 | 119 | 4.5 |

Note:
Ex. stands for Example.
Com. Ex. stands for Comparative Example.

As shown in Table 1, the nonaqueous electrolyte secondary battery laminated separators which were produced in Examples 1 through 5 and which included the porous layers containing the aromatic polyester in accordance with an embodiment of the present invention exhibited lower oxidation current values as compared to the nonaqueous electrolyte secondary battery laminated separator produced in Comparative Example 1. A commercially available lithium ion battery normally has the maximum potential of less than 4.3 V relative to 0 V of Li⁺/Li. It is found that the nonaqueous electrolyte secondary battery laminated separators produced in Examples 1 through 5 could subdue oxidation current values even at 4.5 V which was higher than the maximum potential of a commercially available lithium ion battery, and so exhibited high oxidation resistance in a battery. Furthermore, the nonaqueous electrolyte secondary battery laminated separators produced in Examples 1 through 5 were superior also in terms of piercing strength to the nonaqueous electrolyte secondary battery laminated separator produced in Comparative Example 1.

### INDUSTRIAL APPLICABILITY

The nonaqueous electrolyte secondary battery insulating porous layer in accordance with an embodiment of the present invention is useful as a member of a nonaqueous electrolyte secondary battery.

1. A nonaqueous electrolyte secondary battery insulating porous layer comprising aromatic polyester,
the aromatic polyester containing, as constituent units, (A) a unit derived from aromatic hydroxycarboxylic acid, (B) a unit derived from aromatic dicarboxylic acid, (C) a unit derived from aromatic amine, selected from aromatic diamine and aromatic amine containing a hydroxyl group, and (D) a unit derived from aromatic diol,
the unit (A) being not less than 10 mol % and less than 30 mol %, the unit (B) being more than 35 mol % and not more than 45 mol %, and a sum of the unit (C) and the unit (D) being more than 35 mol % and not more than 45 mol % relative to 100 mol % in total number of moles of the units (A) through (D), and
a molar ratio (D)/(C) of the unit (D) to the unit (C) being not more than 0.75.

2. A nonaqueous electrolyte secondary battery laminated separator comprising:
a porous base material containing a polyolefin-based resin as a main component; and
a nonaqueous electrolyte secondary battery insulating porous layer recited in claim 1, the nonaqueous electrolyte secondary battery insulating porous layer being disposed on at least one surface of the porous base material.

3. A nonaqueous electrolyte secondary battery member comprising:
a cathode;
a nonaqueous electrolyte secondary battery insulating porous layer recited in claim 1; and
an anode,
the cathode, the nonaqueous electrolyte secondary battery insulating porous layer, and the anode being arranged in this order.

4. A nonaqueous electrolyte secondary battery comprising:
a nonaqueous electrolyte secondary battery insulating porous layer recited in claim 1.

5. A nonaqueous electrolyte secondary battery member comprising:
a cathode;
a nonaqueous electrolyte secondary battery laminated separator recited in claim 2; and
an anode,
the cathode, the nonaqueous electrolyte secondary battery laminated separator, and the anode being arranged in this order.

6. A nonaqueous electrolyte secondary battery comprising:
a nonaqueous electrolyte secondary battery laminated separator recited in claim 2.
